(19) United States
(12) Patent Application Publication
(10) Pub. No.: US 2001/0029499 A1
(43) Pub. Date: Oct. 11, 2001

(54) Rules processing system

(76) Inventors: Jeffrey Taihana Tuatini, San Francisco, CA (US); Jun Ying, Atlanta, GA (US)

Correspondence Address: PERKINS COIE LLP, PATENT-SEA, P.O. BOX 1247, SEATTLE, WA, 98111-1247, US

(21) Appl. No.: 09/753,036

(22) Filed: Dec. 28, 2000

Related U.S. Application Data
(60) Provisional application No. 60/173,273, filed on Dec. 30, 1999.

(51) Int. Cl. G06N 5/02; G06F 17/00

(52) U.S. Cl. 706/47

(57) ABSTRACT

A method and system for providing a common interface to rule engines. A common rule engine interface system defines a single interface through which any rule engine can be accessed. The common rule engine interface system specifies a premise fact object and a derived fact object that is used to contain the premise facts and derived facts needed for particular rule engine. The common rule engine interface system also provides a rule set identifier object that identifies a particular set of rules. The system also provides an evaluator component that inputs the premise facts as attributes of the premise fact object and inputs a rule set identifier object and outputs the derived facts generated by the identified rule set.

### CROSS-REFERENCE TO RELATED APPLICATIONS

This application claims the benefit of U.S. Provisional Patent Application No. 60/173,273, entitled “RULES PROCESSING SYSTEM,” filed on Dec. 30, 1999 (Attorney Docket No. 243768006US) and is related to U.S. patent application Ser. No. ______, entitled “APPLICATION ARCHITECTURE,” filed on Dec. 28, 2000 (Attorney Docket No. 243768011US1), the disclosures of which are incorporated herein by reference.

### TECHNICAL FIELD

The described technology relates to a computer-based rule engine.

### BACKGROUND

A rule engine is a software component that inputs certain premise facts and applies rules to those premise facts to generate derived facts. For example, a premise fact may be a customer name and the rules may map each customer name to a preferred carrier. When a customer name (i.e., a premise fact) is provided to the rule engine, the rule engine derives the preferred carrier (i.e., a derived fact) for that customer from the rules. In general, a rule engine applies premise facts to a database of rules to generate the derived facts that apply to those premise facts. A difficulty with rule engines is that different suppliers of rule engines define different and incompatible application programming interfaces to their rule engines. For example, one rule engine may be developed especially for applying rules relating to shipping information, whereas another rule engine may be developed especially for applying rules relating to computer resources (e.g., application programs) that users are authorized to use. If an application program needs to use multiple rule engines, then the programmer would need to learn and use each interface of each rule engine.

Also, because each rule engine defines its own application programming interface, an application program would need to be modified when a switch is made from one rule engine to another rule engine. Because of the costs associated with the modifications, companies are reluctant to switch rule engines even though a rule engine with better performance becomes available. It would be desirable to have a technique that would reduce the effort needed to learn the application programming interfaces of multiple rule engines and reduce the costs of switching rule engines.

### BRIEF DESCRIPTION

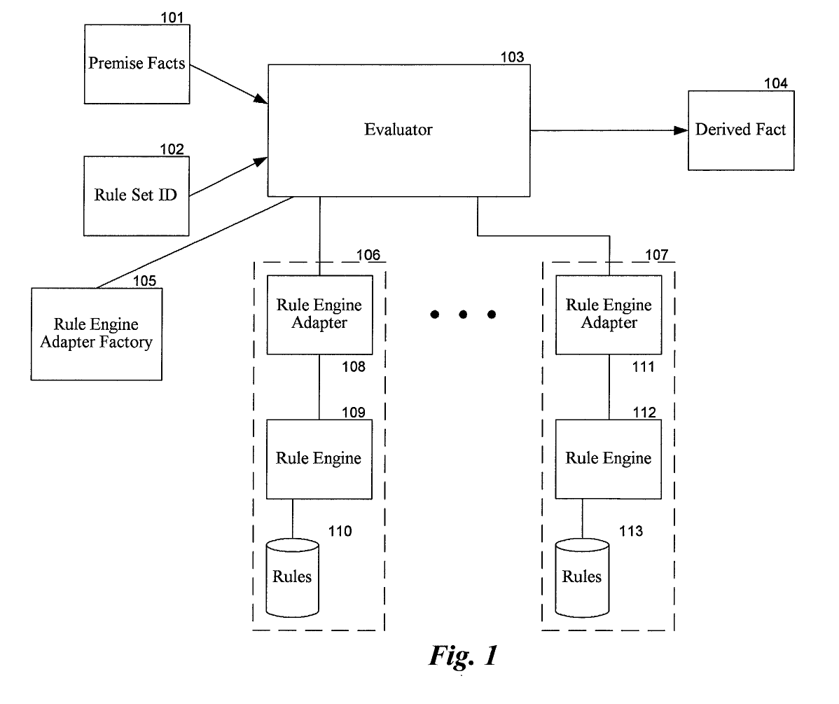

FIG. 1 is a block diagram illustrating components of the common rule engine interface system.

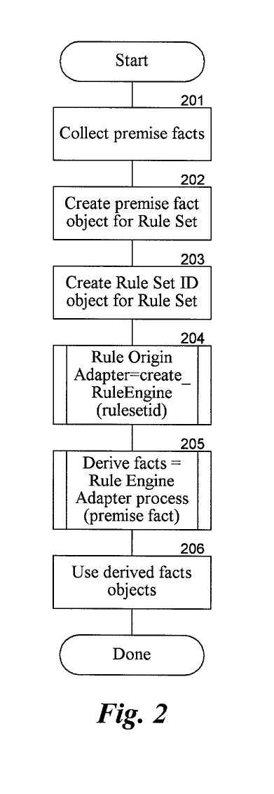

FIG. 2 is a flow diagram illustrating the process performed by an application program in using the common rule engine interface.

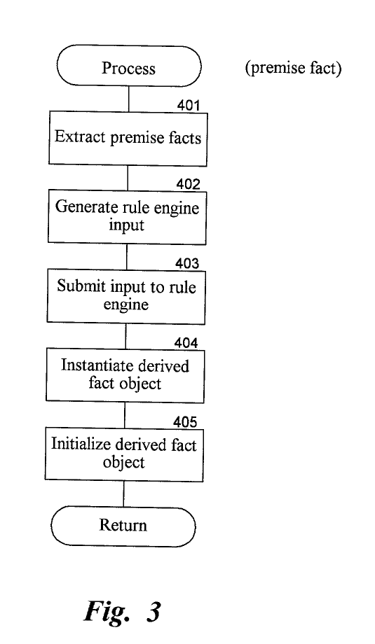

FIG. 3 is a flow diagram of the process performed by the rule engine adapter factory to create a rule engine adapter.

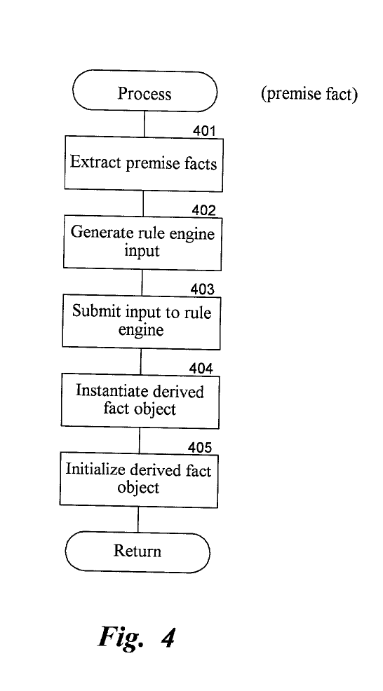

FIG. 4 is a flow diagram illustrating the processing of premise facts by a rule engine adapter.

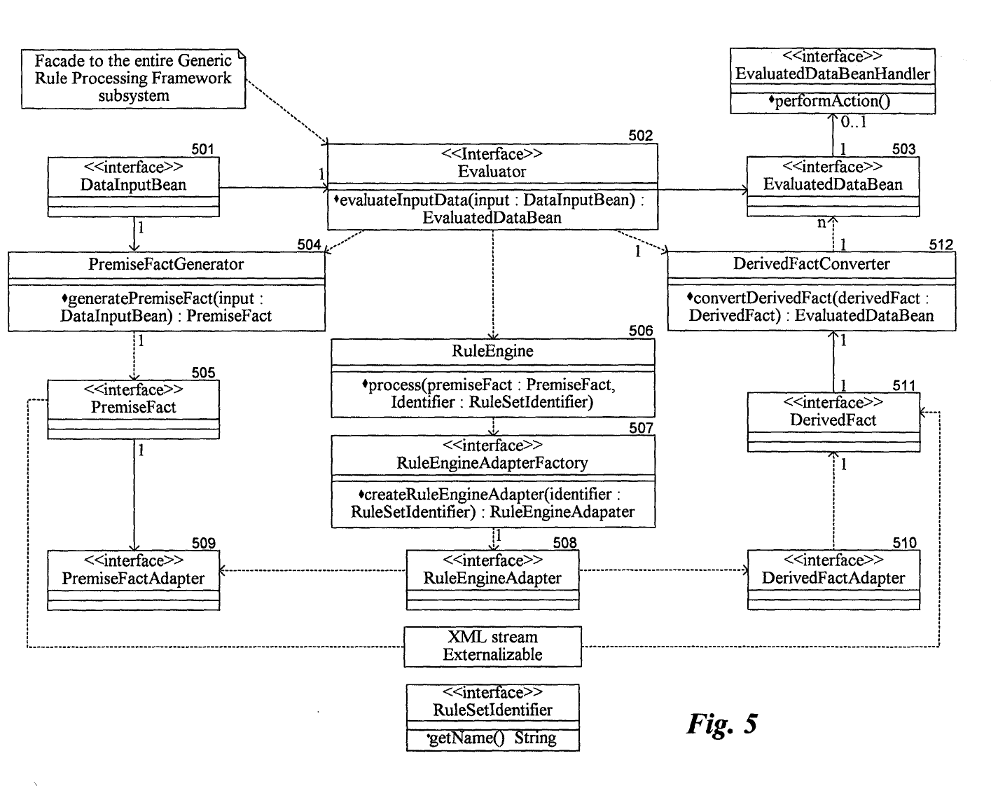

FIG. 5 is a block diagram illustrating an alternate organization of the common rule engine interface.

### DETAILED DESCRIPTION

A method and system for providing a common interface to rule engines is provided. In one embodiment, a common rule engine interface system defines a single interface through which any rule engine can be accessed. In this way, a programmer need only use the common rule interface system to interface with any rule engine. The common rule engine interface system specifies a premise fact object and a derived fact object that is used to contain the premise facts and derived facts needed for particular rule engine. The common rule engine interface system also provides a rule set identifier object that identifies a particular set of rules. The system also provides an evaluator component that inputs the premise facts as attributes of the premise fact object and inputs a rule set identifier object and outputs the derived facts generated by the identified rule set. An application program need only be aware of the premise facts and derived facts that are defined by the identified rule set. The evaluator controls the mapping of input and output to the interface provided by the rule engine of the identified rule set.

FIG. 1 is a block diagram illustrating components of the common rule engine interface system. The system includes a premise fact object 101, a rule set identifier object 102, an evaluator 103, a derived fact object 104, a rule engine adapter factory 105, and rule sets 106 and 107. Each rule set has associated with it class definitions for its premise fact and derived fact objects. For example, the class for a premise fact object may define a get method and a set method for each fact that is used by the rule set. An application program uses the set methods to set the premise facts prior to invoking the evaluator. The rule set identifier object is provided by a rule set as an identification of that rule set. Each rule set includes a rule engine adapter 108, a rule engine 109, and a rules database 110. The evaluator invokes the rule engine adapter factory to generate a rule engine adapter appropriate for the rule set that is identified by the rule set identifier object. The rule engine adapter is responsible for mapping the premise facts in a premise fact object to the application program interface provided by its rule engine and mapping the derived facts returned from the rule engine to a derived fact object. After generating the rule engine adapter, the evaluator invokes the rule engine adapter passing the premise fact object and receiving a derived fact object in return. Whenever a rule engine with a new rule database is defined, a rule engine adapter is also defined to support the common rule engine interface. The system may be implemented using a computer that includes a central processing unit, memory, input device (e.g., keyboard and pointing devices), output devices (e.g., display devices), and storage devices (e.g., disk drives). The memory and storage devices are computer-readable media that may contain instructions that implement the software of the system. In addition, data structures and message structures used by the system may be stored or transmitted via a data transmission medium, such as a signal on a communications link. Also, the various components of the system may reside on the same computer or different computers. For example, the rule engines may reside on a rule engine server that services requests sent from client computers where the rule engine adapters reside.

FIG. 2 is a flow diagram illustrating the process performed by an application program in using the common rule engine interface. In block 201, the application initially collects premise facts. These premise facts may be collected from a user or retrieved from a database. In block 202, the application then creates a premise fact object for the particular rule set by which the premise facts are to be processed. Each rule set has an associated premise fact object for storing the facts appropriate to the rule set. The application invokes the set methods of the premise fact object to set the premise facts. In block 203, the application creates a rules set identifier object for the rule set to be accessed. The class types for the premise fact object and for the rule set identifier object may be stored in a global registry indexed by the rule set identifier so that application program can locate the class types. Blocks 204 and 205 represent processing by the evaluator. The application invokes the evaluator passing the premise fact object and the rule set identifier object. In block 204, the evaluator invokes a method of the rule engine adapter factory passing the rule set identifier object to create a rule engine adapter appropriate to the rule set to be accessed. In block 205, the evaluator invokes the process method of the rule engine adapter passing the premise fact object and receiving a derived fact object in return. The evaluator then returns to the application which retrieves the derived facts from the derived facts object using the get methods and then uses the derived facts as appropriate.

FIG. 3 is a flow diagram of the process performed by the rule engine adapter factory to create a rule engine adapter. The rule engine adapter factory is passed a rule set identifier object that contains information identifying a rule set. This information may be stored as a string within the rule set identifier object. In block 301, the factory extracts the rule set identifier from the rule set identifier object. In block 302, the factory retrieves the class type of the rule engine adapter for the identified rule set. A mapping of rule set identifier to the class type of the rule engine adapter may be stored in a global registry. In block 303, the factory instantiates a rule engine adapter object of the retrieve class type. In block 304, the factory initializes the rule engine adapter. This initialization may include the storing of a reference to a rule engine object that supports the specific application programming interface of the rule engine. The factory then returns.

FIG. 4 is a flow diagram illustrating the processing of premise facts by a rule engine adapter. The process method of the rule engine adapter is responsible for extracting the premise facts from the passed premise fact object, invoking the rule engine to process the premise facts, identifying the corresponding derived facts generated by the rule engine, and storing those derived facts in a derived fact object. In block 401, the method extracts the premise facts from the passed premise fact object. In block 402, the method uses the extracted premise facts to generate the data structures needed by the rule engine. In block 403, the method submits the generated data structures to the rule engine. In block 404, the method instantiates a derived fact object for holding the derived facts returned by the rule engine. In block 405, the method initializes the derived fact object with the returned derived facts and then returns.

FIG. 5 is a block diagram illustrating an alternate organization of the common rule engine interface. The common rule engine interface is accessed from an application program through evaluator 502. The application program passes a data input bean (e.g., a JAVA bean) and receives an evaluated data bean 503 in return. The data input bean contains premise facts along with a rule set identifier. The evaluator invokes the premise fact generator 504 passing the data input bean. The premise fact generator converts the data input bean to an XML representation of the premise facts using premise fact component 505. The XML representation uses a standard representation for representing facts. The evaluator also identifies the rule set from the data input bean. The evaluator then invokes the process method of the rule engine component 506 passing the premise facts in the XML format and passing the rule set identifier. The process method then invokes the rule engine adapter factory 507 to create a rule engine adapter 508. The rule engine component 506 then invokes the created rule engine adapter. The rule engine adapter invokes a premise fact adapter 509 for the rule set to put the XML premise facts in a format that is compatible with the identified rule set. The rule engine adapter then invokes the underlying rule engine passing the premise facts using its application programming interface. The rule engine adapter receives the derived facts in return. The rule engine adapter then invokes the derived fact adapter 510 to put the derived facts in XML format. The rule engine adapter then returns to the rule engine component. The rule engine component then returns the derived facts to the evaluator. The evaluator invokes the derived fact converter 512 to convert the derived facts from the XML format to the evaluated data bean format. The evaluator then returns the evaluated data bean.

Although specific embodiments have been described, it is not intended that the invention be limited to these embodiments. One skilled in the art will appreciate that various modifications can be made without deviating from the spirit of the invention. The invention is defined by the claims that follow.

1. A method in a computer system for providing a common interface for accessing different rule engines, the method comprising:
providing a premise fact object representing premise facts;
providing a rule set identifier that identifies rules and a rule engine for processing the rules; and
invoking an evaluator to generate a derived fact object representing facts derived when the identified rule engine applies the identified rules to the premise facts represented by the premise fact object, the evaluator providing a common interface for using a plurality of different rule engines.

2. The method of claim 1 wherein the evaluator invokes a rule engine adapter for the identified rule engine, wherein the rule engine adapter submits the premise facts to the identified rule engine and stores in the derived fact object the derived facts returned by the identified rule engine.

3. The method of claim 2 wherein the evaluator invokes a rule engine adapter factory to instantiate the rule engine adapter.

4. The method of claim 2 wherein the identified rule engine provides an application programming interface that the rule engine adapter uses to submit the premise facts and retrieve the derived facts.

5. The method of claim 1 wherein the premise fact object has a set fuction for each premise fact, the set functions for setting values of the premise facts.

6. The method of claim 1 wherein the derived fact object has a get function for each derived fact, the get functions for retrieving values of the derived facts.

7. The method of claim 1 wherein the premise facts and the rule set identifier are provided by a single data input object.

8. The method of claim 1 wherein the evaluator uses a premise fact generator to convert the premise facts of the premise fact object to another representation.

9. The method of claim 8 wherein the other representation is an XML representation.

10. A computer system for accessing rule engines comprising:
a rule engine for applying rules to premise facts to generate derived facts;
a data input object for storing premise facts to be submitted to a rule engine and for storing a rule set identifier that identifies rules and a rule engine;
a data output object for storing derived facts generated by the identified rule engine; and
an evaluator that retrieves the premise facts from the data input object, that submits the retrieved premise facts to the identified rule engine, that requests the rule engine to apply the identified rules to the submitted premise facts, that retrieves the derived facts generated by the rule engine, and that stores the retrieved derived facts in the data output object.

11. The computer system of claim 10 wherein the evaluator provides the data input object to a rule engine adapter for interfacing with the interface provided with the rule engine.

12. The computer system of claim 10 wherein a computer program uses the data input object and data output object to generated derived facts from premise facts in a way that is independent of an application programming interface provided by the rule engine.

13. The computer system of claim 10 wherein the data input object provides functions for setting values associated with the premise facts.

14. The computer system of claim 10 wherein the data output object provides functions for retrieving values associated with the derived facts.

15. The computer system of claim 10 including a plurality of rule engines and wherein a rule engine is identified based on the rule set identifier.

16. The computer system of claim 15 wherein each rule engine provides a different application programming interface.

17. A computer system for accessing rule engines comprising:
a rule engine for applying rules to premise facts to generate derived facts;
means for storing premise facts to be submitted to a rule engine and for storing a rule set identifier that identifies rules and a rule engine;
means for storing derived facts generated by the identified rule engine; and
means for retrieving the premise facts from the stored premise facts, for submitting the retrieved premise facts to the identified rule engine, for requesting the rule engine to apply the identified rules to the submitted premise facts, for retrieving the derived facts generated by the rule engine, and for storing the retrieved derived facts in accordance with the means for storing derived facts.

18. The computer system of claim 17 wherein the means for storing premise facts is a premise fact object.

19. The computer system of claim 18 wherein the means for retrieving provides the premise fact object to a rule engine adapter for interfacing with the interface provided with the rule engine.

20. The computer system of claim 17 wherein the means for storing premise facts and means for storing derived facts are independent of an application programming interface provided by the rule engine.

21. The computer system of claim 17 wherein the means for storing premise facts provides functions for setting values associated with the premise facts.

22. The computer system of claim 17 wherein the means for storing derived facts provides functions for retrieving values associated with the derived facts.

23. The computer system of claim 17 including a plurality of rule engines and wherein a rule engine is identified based on the rule set identifier.

24. The computer system of claim 23 wherein each rule engine provides a different application programming interface.

25. A computer-readable medium containing:
a premise fact object representing premise facts;
a rule set identifier that identifies rules and a rule engine for processing the rules; and
an evaluator that generates a derived fact object representing facts derived when the identified rule engine applies the identified rules to the premise facts, the evaluator providing a common interface for using a plurality of different rule engines.

26. The computer-readable medium of claim 25 wherein the evaluator includes a rule engine adapter for the identified rule engine, wherein the rule engine adapter submits the premise facts to the identified rule engine and generates the derived fact object for the derived facts returned by the identified rule engine.

27. The computer-readable medium of claim 26 wherein the evaluator invokes a rule engine adapter factory to instantiate the rule engine adapter.

28. The computer-readable medium of claim 26 wherein the identified rule engine provides an application programming interface that the rule engine adapter uses to submit the premise facts and retrieve the derived facts.

29. The computer-readable medium of claim 25 wherein the premise fact object has a set function for each premise fact, the set functions for setting values of the premise facts.

30. The computer-readable medium of claim 25 wherein the derived fact object has a get function for each derived fact, the get functions for retrieving values of the derived facts.

31. The computer-readable medium of claim 25 wherein the premise facts and the rule set identifier are provided by a single data input object.

32. The computer-readable medium of claim 25 wherein the evaluator uses a premise fact generator to convert the premise facts of the premise fact object to another representation.

33. The computer-readable medium of claim 32 wherein the other representation is an XML representation.
